(19) United States
(12) Patent Application Publication
(10) Pub. No.: US 2015/0044432 A1
(43) Pub. Date: Feb. 12, 2015

(54) TOUCH PANEL STRUCTURE AND METHOD FOR FORMING THE SAME

(71) Applicant: CANDO CORPORATION, Hsinchu County (TW)

(72) Inventors: CHUNG-CHI WANG, Hsinchu County (TW); KAO-HUI SU, Hsinchu County (TW)

(21) Appl. No.: 14/297,401

(22) Filed: Jun. 5, 2014

(30) Foreign Application Priority Data
Aug. 7, 2013 (TW) 102128231

(51) Int. Cl. G06F 1/16

(52) U.S. Cl. CPC G06F 1/16
USPC 428/201; 427/126.3

(57) ABSTRACT

The present invention discloses a touch panel structure and a method for forming the same. A touch panel structure according to the present invention comprises a substrate, a first color layer, a second color layer, and an indium tin oxide (ITO) conductive layer. The first color layer is disposed on a surface of the substrate. The second color layer is disposed on a surface of the first color layer which is opposite to the substrate, and a portion of the second color layer extends further to be in contact with the substrate. The ITO conductive layer is disposed on a surface of the second color layer which is opposite to the first color layer and also disposed on the surface of the substrate. With the touch panel structure of the present invention, the conductive layer will not break easily, and the yield rates for touch panels will be improved.

### CROSS-REFERENCE TO RELATED APPLICATIONS

The present application claims priority to and the benefit of Taiwan Patent Application No. 102128231, filed on Aug. 7, 2013, the entire content of which is incorporated herein by reference.

### BACKGROUND OF THE INVENTION

1. Field of the Invention

The present invention relates to a touch panel structure and a method for forming the same; more particularly, the present invention relates to a touch panel structure which improves the problem that the conductive layer therein may break easily, and to a method for forming such a touch panel structure.

2. Description of the Prior Art

As touch panel technology keeps advancing while consumer electronics gain increasing popularity in recent years, touchscreens are even more widely used in many products. Touchscreens used to be adopted in particular product categories, but now, a wide range of electronic product manufacturers have adopted touchscreen as a fundamental part of a product. Touchscreens have become a popular application that has a fast growing market.

FIGS. 1A and 1B are first schematic views showing part of an existing touch panel structure; FIGS. 2A and 2B are second schematic views showing the same. As shown in these drawings, an existing touch panel structure 1, which is manufactured based on Colorful One Glass Solution (Colorful OGS) technology, mainly comprises a substrate 11 and at least one color layer disposed on a surface of the substrate 11. Generally, the color layers may be configured to consist of one layer, consist of two layers, (e.g., color layers 12 and 13 in FIG. 1A) or consist of more layers (e.g., color layers 12, 13, and 14 in FIG. 2A) depending on the needs. In real practice, the color layers are generally configured to consist of two or more layers to create the visual effect of light colors; that is, the visual effect of light colors can be created through the use of thick layers.

The color layers of an existing Colorful OGS touch panel are often stacked in a manner that the edges of the color layers are gradually recessed on a layer-by-layer basis (as shown in FIG. 1A and FIG. 2A). This structure represents a conventional stack structure of color layers that is commonly used. However, this conventional stack structure is disadvantageous in that there is a clear descent between the surfaces of the stacked layers; that is, a steep slope exists at the junction where two layers meet, creating a sharp decline in thickness. As the conductive layer 15 needs to be coated on the slopes at the edges of the color layers (see e.g., the slopes at the edges of the color layers 12, 13 in FIG. 1B, or the slopes at the edges of the color layers 12, 13, 14 in FIG. 2B), the aforementioned problem may result in that the conductive layer 15 on the top may break easily during the formation (see e.g., the dotted circle 16 shown in FIG. 1B or the dotted circles 17, 18 shown in FIG. 2B). And this may further affect the connection yield for the conductive layer 15.

How to overcome the above problem that the conductive layer 15 may break easily has thus become an important topic. Hence, there exists a need in the market for an ideal touch panel structure and a method for forming the same, which can effectively solve the problem that the conductive layer may break easily due to the stack structure during the manufacture of electronic products with the Colorful OGS touch panels.

### SUMMARY OF THE INVENTION

In view of the above drawbacks of the prior art technique, an object of the present invention is to provide a touch panel structure and a method for forming the same, which can solve the problem that the conductive layer may break easily due to the stack structure during the manufacture of electronic products with the Colorful OGS touch panels.

According to an aspect of the present invention, there is provided a touch panel structure comprising a substrate, a first color layer, a second color layer, and an indium tin oxide (ITO) conductive layer. The first color layer is disposed on a surface of the substrate. The second color layer is disposed on a surface of the first color layer which is opposite to the substrate, and a portion of the second color layer extends further to be in contact with the substrate. The ITO conductive layer is disposed on a surface of the second color layer which is opposite to the first color layer and also disposed on the surface of the substrate.

According to another aspect of the present invention, there is provided a method for forming a touch panel structure comprising: providing a substrate; providing a first color layer on a surface of the substrate; providing a second color layer on a surface of the first color layer which is opposite to the substrate and causing a portion of the second color layer to extend further to be in contact with the substrate; and providing an ITO conductive layer on a surface of the second color layer which is opposite to the first color layer and also on the surface of the substrate.

According to a further aspect of the present invention, there is provided a touch panel structure comprising a substrate, a plurality of color layers, and an ITO conductive layer. The plurality of color layers are stacked sequentially on a surface of the substrate, with a portion of an uppermost color layer extending further to be in contact with the substrate. The ITO conductive layer is disposed on an upper surface of the uppermost color layer and also disposed on the surface of the substrate.

According to yet another aspect of the present invention, there is provided a method for forming a touch panel structure comprising: providing a substrate; stacking a plurality of color layers sequentially on a surface of the substrate and causing an uppermost color layer to extend further to be in contact with the substrate; and providing an ITO conductive layer on an upper surface of the uppermost color layer and also on the surface of the substrate.

The aforementioned aspects and other aspects of the present invention will be better understood with reference to the following exemplary embodiments and drawings.

### BRIEF DESCRIPTION OF THE DRAWINGS

FIG. 1A and FIG. 1B are first schematic views showing part of an existing touch panel structure.

FIG. 2A and FIG. 2B are second schematic views showing part of an existing touch panel structure.

FIG. 3A and FIG. 3B are cross-sectional views of a touch panel structure according to a first embodiment of the present invention.

FIG. 4A and FIG. 4B are cross-sectional views of a touch panel structure according to a second embodiment of the present invention.

FIG. 5A and FIG. 5B are cross-sectional views of a touch panel structure according to a third embodiment of the present invention.

FIG. 6 is a schematic view showing part of a touch panel structure in a product example according to an embodiment of the present invention.

FIG. 7 is a flow chart showing a method for forming a touch panel structure according to an embodiment of the present invention.

FIG. 8 is a flow chart showing a method for forming a touch panel structure according to another embodiment of the present invention.

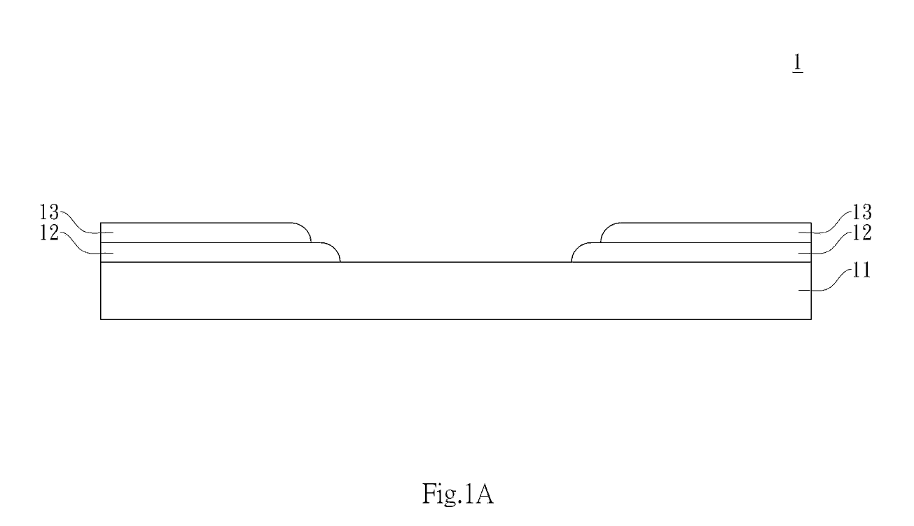

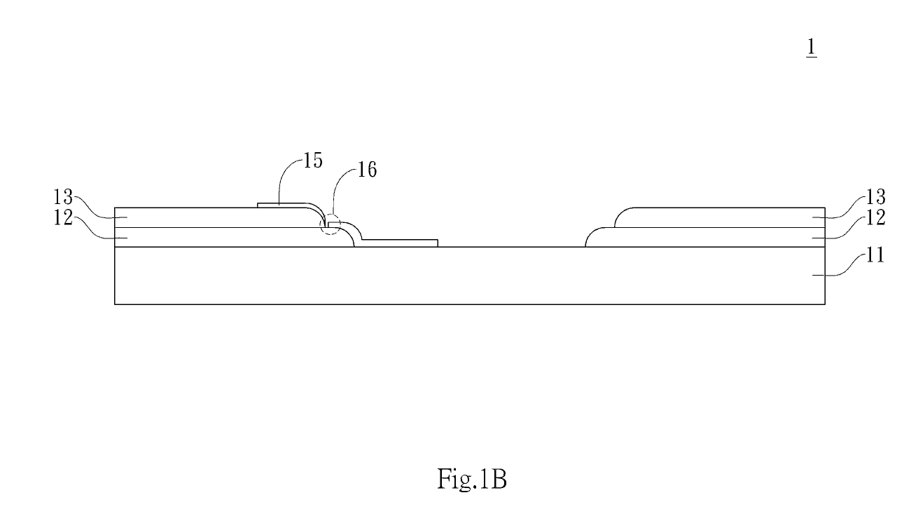

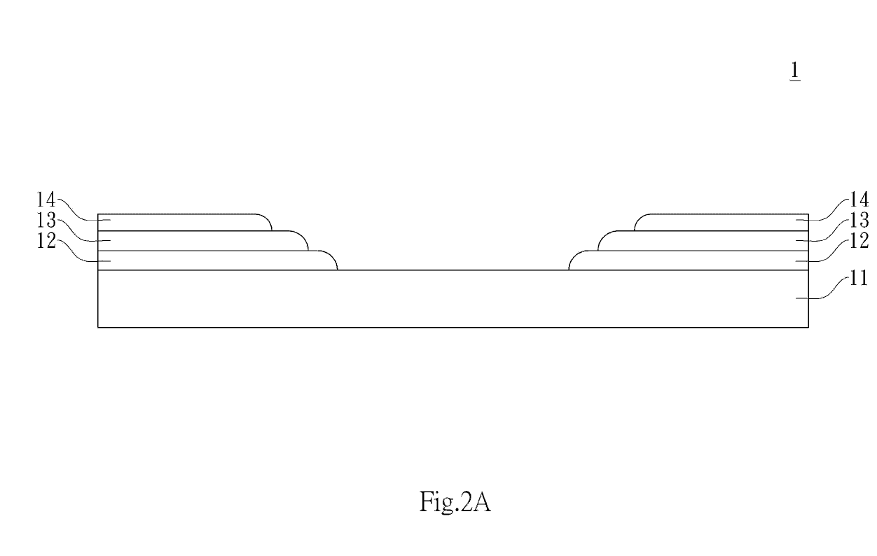

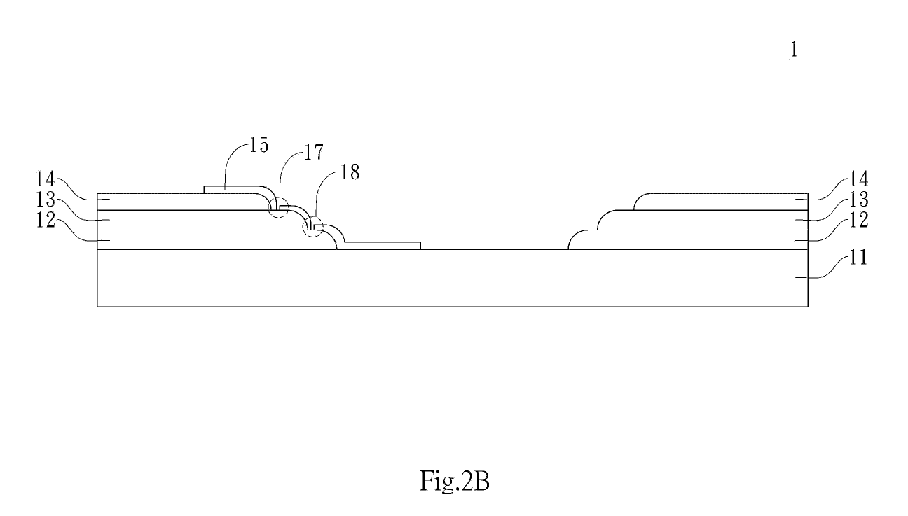

### DETAILED DESCRIPTION OF THE PREFERRED EMBODIMENTS

The present invention will be fully described by way of preferred embodiments and appended drawings to facilitate the understanding of the technical features, contents and advantages of the present invention. It will be understood that the appended drawings are merely schematic representations and may not be illustrated according to actual scale and precise arrangement of the implemented invention. Therefore, the present invention shall not be construed based on the scale and arrangement illustrated on the appended drawings, and the embodiments and appended drawings are not intended to limit the scope of protection of the present invention.

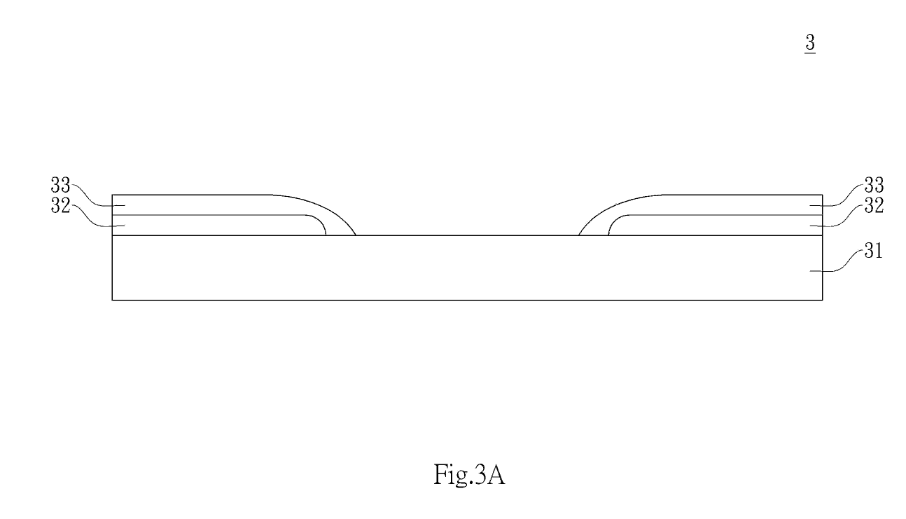

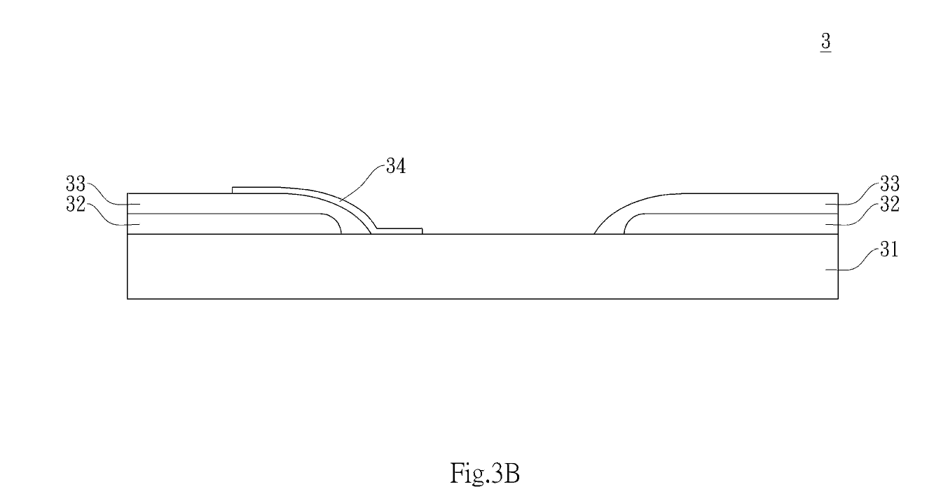

FIGS. 3A and 3B are cross-sectional views of a touch panel structure according to a first embodiment of the present invention, illustrating a basic construction of the touch panel structure according to the present invention. As shown in FIGS. 3A and 3B, a touch panel structure 3 of the first embodiment of present invention mainly comprises a substrate 31, a first color layer 32, a second color layer 33, and an indium tin oxide (ITO) conductive layer 34. The first color layer 32 may be disposed on a surface of the substrate 31. The second color layer 33 may be disposed on a surface of the first color layer 32 which is opposite to the substrate 31, and a portion of the second color layer 33 may extend further to be in contact with the substrate 31. Preferably, the color layers 32 and 33 may have a total thickness of more than 5 μm and a transmittance of more than 1%. In this embodiment, the color layers 32 and 33 may preferably be of the same color or of different colors, and may preferably comprise ink or photoresist; however, the materials used for the color layers are not limited to those as described above in real practice.

Further, a portion of the second color layer 33 of the touch panel structure 3 extends further to be in contact with the substrate 31. That is, the edge of the second color layer 33 at the top fully covers the edge of the first color layer 32 at the bottom, so that a more smooth slope is resulted from the edge of the stacked layers. As a result, given the more smooth slope at the edge of the stacked layers, the ITO conductive layer 34 disposed on the surface of the second color layer 33 and on the surface of the substrate 31 will not break easily during the formation.

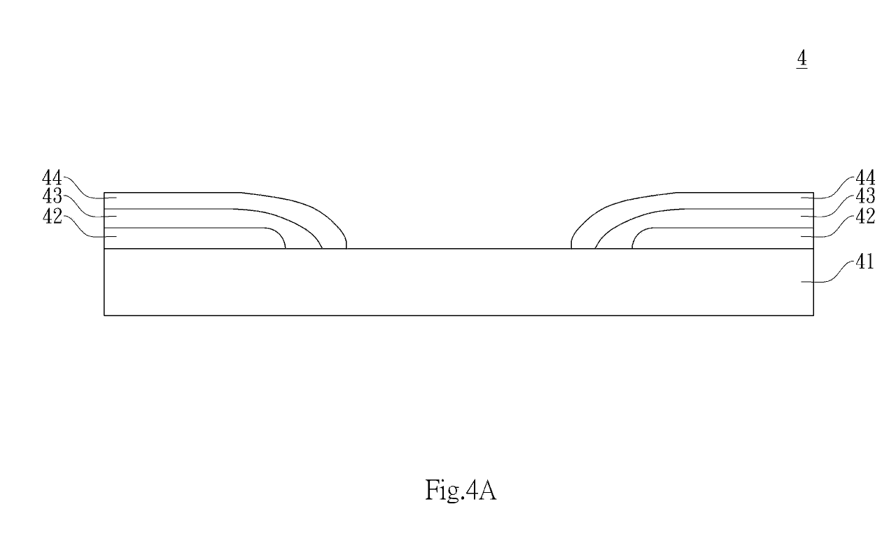

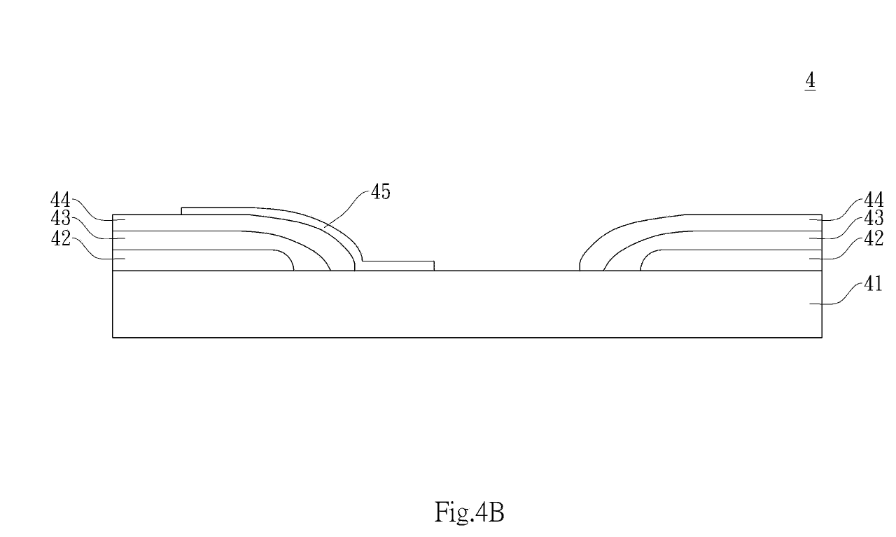

FIGS. 4A and 4B are cross-sectional views of a touch panel structure according to a second embodiment of the present invention, illustrating another basic construction of the touch panel structure according to the present invention. As shown in FIGS. 4A and 4B, the touch panel structure in the second embodiment is basically similar to that in the first embodiment.

Compared with the touch panel structure 3 in the first embodiment, however, the touch panel structure 4 in this embodiment has a three-layer structure. A portion of a second color layer 43 extends further to cover a first color layer 42 at the bottom. Also, a portion of a third color layer 44 extends further to cover the second color layer 43 and comes in contact with a substrate 41. That is, the edge of the third color layer 44 at the top fully covers the edge of the second color layer 43, so that a more smooth slope is resulted from the edge of the stacked layers. As a result, given the more smooth slope at the edge of the stacked layers, the ITO conductive layer 45 disposed on the surface of the third color layer 44 and on the surface of the substrate 41 will not break easily during the formation.

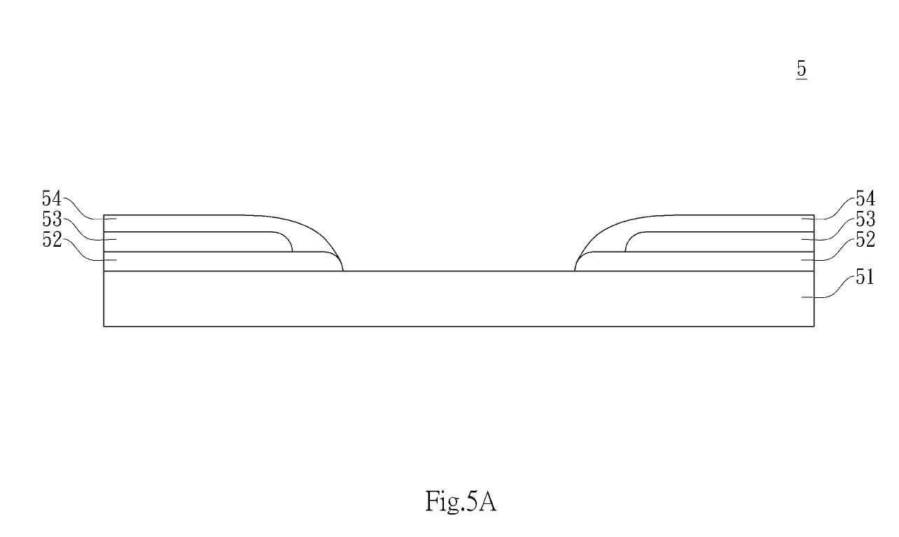

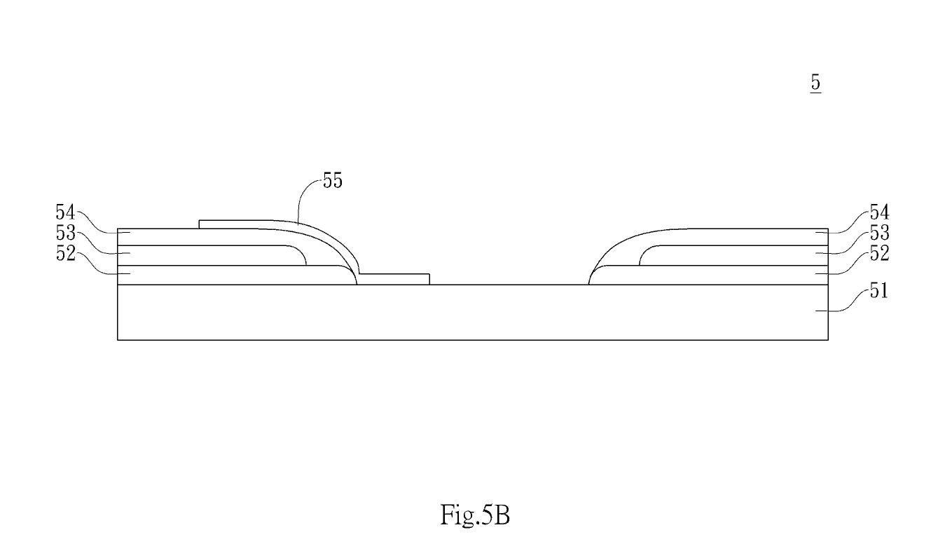

FIGS. 5A and 5B are cross-sectional views of a touch panel structure according to a third embodiment of the present invention, illustrating yet another basic construction of the touch panel structure according to the present invention. As shown in FIGS. 5A and 5B, the touch panel structure in the third embodiment is basically similar to those in the first and second embodiments.

However, this embodiment is different from the second embodiment in that a second color layer 53 of the touch panel structure 5 does not extend further to cover a first color layer 52 at the bottom. Moreover, a portion of a third color layer 54 extends further to cover the second color layer 53 and the first color layer 52 and comes in contact with the substrate 51. That is, the edge of the third color layer 54 at the top fully covers the edge of the second color layer 53 and the edge of the first color layer 52, so that a more smooth slope is resulted from the edge of the stacked layers. As a result, given the more smooth slope at the edge of the stacked layers, the ITO conductive layer 55 disposed on the surface of the third color layer 54 and on the surface of the substrate 51 will not break easily during the formation.

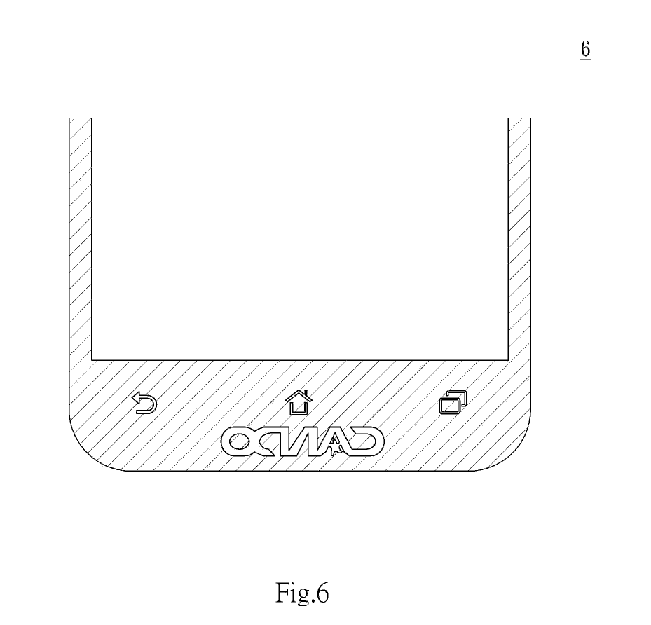

FIG. 6 is a schematic view showing part of a touch panel structure in a product example according to an embodiment of the present invention; this figure illustrates a touch device according to the embodiment of the present invention. A touch panel structure 3, 4, or 5 according to above mentioned embodiments may be provided in a touch device 6 shown in FIG. 6. Each touch panel structure 3, 4, or 5 may comprise the substrate, color layers, and the ITO conductive layer as described above in the first, second, or third embodiment, wherein a more smooth slope is provided at the edge of the stacked layers so that the ITO conductive layer disposed on the surface of the uppermost color layer and on the surface of the substrate will not break easily during the formation. The touch device 6 may be, for example, a touchscreen monitor, a portable mobile device with a touchscreen, or an electronic appliance incorporating touch technology, but is not limited to these examples.

It should be noted that a person having ordinary knowledge in the art shall understand that the transmittance, materials, and number of the color layers described in the foregoing embodiments are exemplary and are not intended to limit the present invention. Any touch panel structure made without departing from the spirit and scope of the present invention falls within the scope of the present invention.

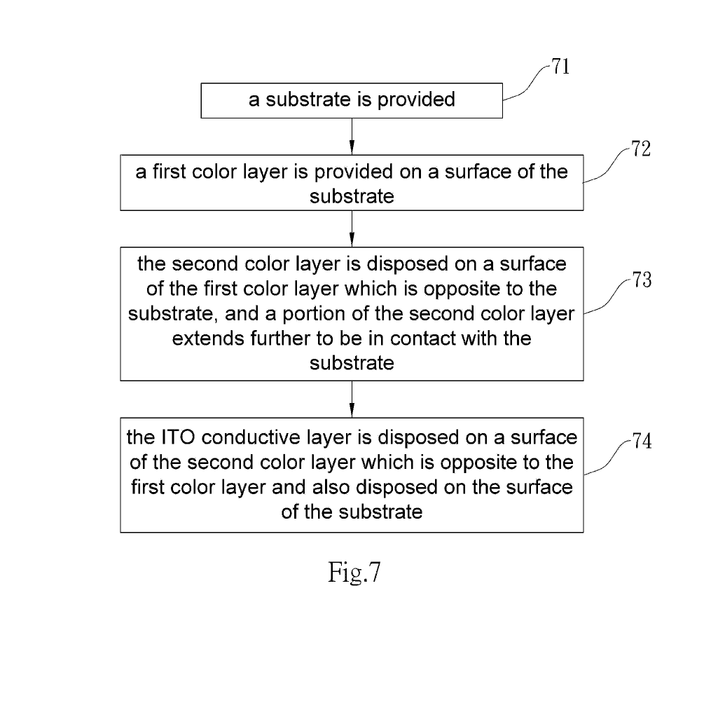

FIG. 7 is a flow chart showing a method for forming a touch panel structure according to an embodiment of the present invention. As FIG. 7 shows, a method for forming a touch panel structure according to the present invention may comprise the following steps. In step 71, a substrate is provided; the substrate may be a cover lens. In step 72, a first color layer is provided on a surface of the substrate. In an embodiment of the present invention, ink is used to form the color layer provided on the surface of the substrate. In step 73, the second color layer is disposed on a surface of the first color layer which is opposite to the substrate, and a portion of the second color layer extends further to be in contact with the substrate. In step 74, the ITO conductive layer is disposed on a surface of the second color layer which is opposite to the first color layer and also disposed on the surface of the substrate.

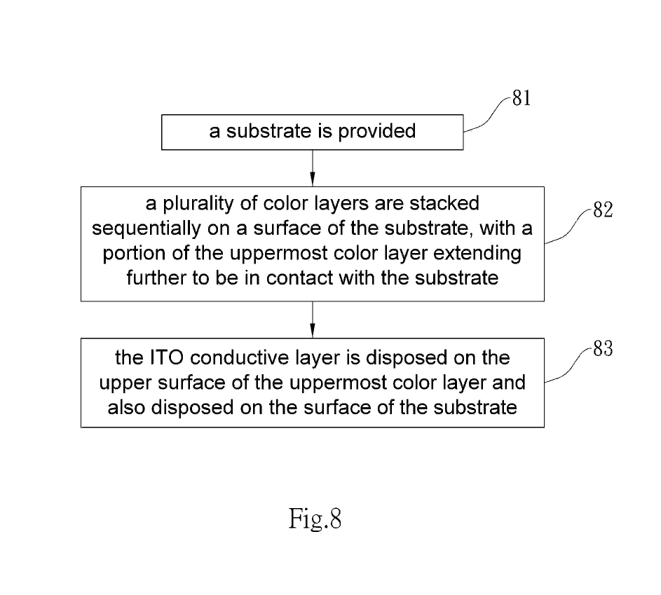

FIG. 8 is a flow chart showing a method for forming a touch panel structure according to another embodiment of the present invention. As FIG. 8 shows, a method for forming a touch panel structure according to the present invention may comprise the following steps. In step 81, a substrate is provided; the substrate may be a cover lens. In step 82, a plurality of color layers are stacked sequentially on a surface of the substrate, with a portion of the uppermost color layer extending further to be in contact with the substrate. In an embodiment of the present invention, ink is used to form the color layers provided on the surface of the substrate. In step 83, the ITO conductive layer is disposed on the upper surface of the uppermost color layer and also disposed on the surface of the substrate.

In sum, the present invention provides a touch panel structure and a method for forming the same, and has at least the following advantages: (1) The plurality of color layers can be of same or different colors to add visual effect varieties as desired. (2) The color layers of a sufficient thickness can have sufficient color saturation. (3) The stacked color layers have a steadier decline in thickness, and a more gentle slope is obtained at the edge of the stacked layers; as a result, the conductive layer disposed on the stacked layers will not break easily during the formation, and the yield rates for Colorful OGS touch panels can thus be improved.

The present invention, which includes a touch panel structure and a method for forming the same, has been described above by way of preferred embodiments with reference to the accompanying drawings. All of the advantageous features disclosed in this specification may be combined in any combination. Each feature disclosed in this specification may be replaced by an alternative feature serving the same, equivalent, or similar purpose. Thus, except for those particularly distinctive features, each feature disclosed is only an example of a generic series of equivalent or similar features. Given the above description of preferred embodiments, those skilled in the art would understand that the present invention features several aspects of novelty and inventive step over the prior art and is industrially applicable. Various modifications and substitutions may be made by those skilled in the art without departing from the spirit and scope of the present invention.

What is claimed is:

1. A touch panel structure, comprising:
a substrate;
a first color layer disposed on a surface of the substrate;
a second color layer disposed on a surface of the first color layer which is opposite to the substrate, a portion of the second color layer extending further to be in contact with the substrate; and
an indium tin oxide (ITO) conductive layer disposed on a surface of the second color layer which is opposite to the first color layer and also disposed on the surface of the substrate.

2. The touch panel structure according to claim 1, wherein the color layers comprise ink or photoresist.

3. The touch panel structure according to claim 1, wherein a total thickness of the color layers is more than 5 μm.

4. A method for forming a touch panel structure, comprising:
providing a substrate;
providing a first color layer on a surface of the substrate;
providing a second color layer on a surface of the first color layer which is opposite to the substrate and causing a portion of the second color layer to extend further to be in contact with the substrate; and
providing an ITO conductive layer on a surface of the second color layer which is opposite to the first color layer and also on the surface of the substrate.

5. The method according to claim 4, wherein the color layers comprise ink or photoresist.

6. The method according to claim 4, wherein a total thickness of the color layers is more than 5 μm.

7. A touch panel structure, comprising:
a substrate;
a plurality of color layers stacked sequentially on a surface of the substrate, with a portion of an uppermost color layer extending further to be in contact with the substrate; and
an ITO conductive layer disposed on an upper surface of the uppermost color layer and also disposed on the surface of the substrate.

8. The touch panel structure according to claim 7, wherein the color layers comprise ink or photoresist.

9. The touch panel structure according to claim 7, wherein a total thickness of the color layers is more than 5 μm.

10. A method for forming a touch panel structure, comprising:
providing a substrate;
stacking a plurality of color layers sequentially on a surface of the substrate and causing an uppermost color layer to extend further to be in contact with the substrate; and
providing an ITO conductive layer on an upper surface of the uppermost color layer and also on the surface of the substrate.
